(19) United States
(12) Patent Application Publication
(10) Pub. No.: US 2017/0154437 A1
(43) Pub. Date: Jun. 1, 2017

(54) IMAGE PROCESSING APPARATUS FOR PERFORMING SMOOTHING ON HUMAN FACE AREA

(71) Applicant: CASIO COMPUTER CO., LTD., Tokyo (JP)

(72) Inventor: Takeshi SATO, Tokyo (JP)

(73) Assignee: CASIO COMPUTER CO., LTD., Tokyo (JP)

(21) Appl. No.: 15/278,850

(22) Filed: Sep. 28, 2016

(30) Foreign Application Priority Data
Dec. 1, 2015 (JP) 2015-234702

(51) Int. Cl. G06T 7/40; G06T 3/40; G06T 7/00

(52) U.S. Cl. CPC G06T 7/40; G06T 7/0081; G06T 3/40; G06T 7/0085; G06T 2207/30201; G06T 2207/20112; G06T 2207/20182

(57) ABSTRACT

An imaging apparatus includes a smoothing section that performs smoothing on a human face area included in an image, an area specifying section that specifies a specific area in the human face area, and a sharpening section that performs processing for reducing a smoothing effect on the specified specific area.

### CROSS REFERENCE TO RELATED APPLICATION

This application claims the benefit of priority under 35 USC 119 of Japanese Patent Application No. 2015-234702 filed on Dec. 1, 2015, the entire disclosure of which is incorporated herein by reference in its entirety.

### BACKGROUND OF THE INVENTION

1. Field of the Invention

The present invention relates to an image processing apparatus, an image processing method and a storage medium.

2. Description of the Related Art

One of the techniques known in the art to make a human face in an image look more beautiful is smoothing, which makes spots and wrinkles in the skin less noticeable, as in JP 2009-70260A.

### SUMMARY OF THE INVENTION

According to an aspect of the present invention, there is provided an image processing apparatus, including: a processor that is configured to: perform smoothing on a human face area in an image; specify at least one specific area in the human face area; and perform processing for reducing an effect of smoothing on the specified specific area.

According to another aspect of the present invention, there is provided an image processing method by using an image processing apparatus, including: performing smoothing on a human face area in an image; specifying at least one specific area in the human face area; and performing processing for reducing an effect of smoothing on the specified specific area.

According to still another aspect of the present invention, there is provided a non-transitory computer-readable storage medium storing therein a program that makes a computer of an image processing apparatus achieve the functions of: performing smoothing on a human face area in an image; specifying at least one specific area in the human face area; and performing processing for reducing an effect of smoothing on the specified specific area.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention will become more fully understood from the detailed description given hereinbelow and the appended drawings, and wherein:

FIG. 1 is a block diagram illustrating the schematic configuration of an imaging apparatus according to an embodiment of the present invention;

FIG. 2 is a flowchart of an example of the procedure of eye enhancement performed by the imaging apparatus of FIG. 1;

FIG. 3 is a flowchart of the procedure of the eye enhancement continued from FIG. 2;

FIG. 4A to FIG. 4D illustrate the eye enhancement of FIG. 2;

FIG. 5A to FIG. 5D illustrate the eye enhancement of FIG. 2; and

FIG. 6A to FIG. 6D illustrate the eye enhancement of FIG. 2.

### DETAILED DESCRIPTION OF THE PREFERRED EMBODIMENTS

Hereinafter, specific embodiments of the present invention will be described with drawings. However, the scope of the invention is not limited to the illustrated examples.

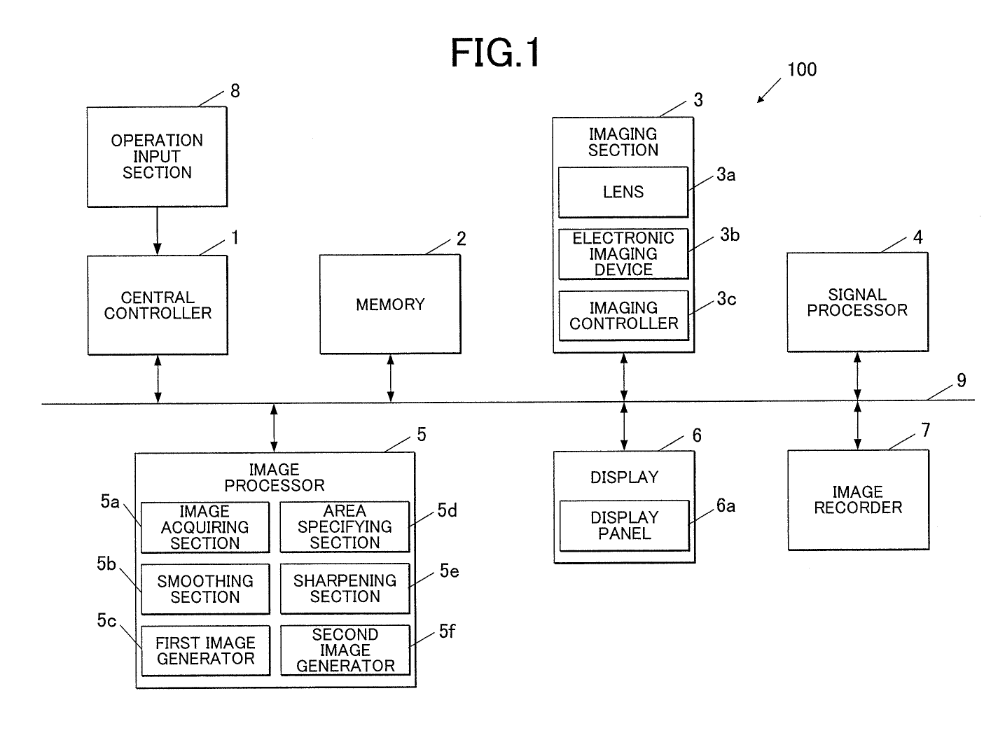

FIG. 1 is a block diagram illustrating the schematic configuration of an imaging apparatus 100 according to an embodiment of the present invention.

Specifically, as illustrated in FIG. 1, the imaging apparatus 100 of the embodiment includes a central controller 1, a memory 2, an imaging section 3, a signal processor 4, an image processor 5, a display 6, an image recorder 7 and an operation input section 8.

The central controller 1, the memory 2, the imaging section 3, the signal processor 4, the image processor 5, the display 6 and the image recorder 7 are connected to each other through a bus line 9.

The central controller 1 controls the components of the imaging apparatus 100. Specifically, the central controller 1, which, although they are not shown in the drawings, includes a CPU (central processing unit) and the like, performs various control operations according to various processing programs (not shown) for the imaging apparatus 100.

The memory 2, which is constituted by a DRAM (dynamic random access memory) for example, temporarily stores data to be processed by the central controller 1 and the image processor 5, and the like.

The imaging section 3 takes an image of a subject. Specifically, the imaging section 3 includes a lens 3a, an electronic imaging device 3b and an imaging controller 3c.

For example, the lens 3a is constituted by lenses including a zoom lens and a focusing lens.

For example, the electronic imaging device 3b is constituted by an imaging sensor such as a CCD (charge coupled device) or a CMOS (complementary metal-oxide semiconductor). The electronic imaging device 3b converts an optical image that has passed through the lenses of the lens 3a to a two-dimensional image signal.

For example, the imaging controller 3c includes a timing generator, a driver and the like. The imaging controller 3c scan-drives the electronic imaging device 3b by means of the timing generator and the driver so that the electronic imaging device 3b converts the optical image that has passed through the lens 3a to a two-dimensional image signal on a predetermined cycle. The imaging controller 3c reads frame images one by one from an imaging area of the electronic imaging device 3b and outputs them to the signal processor 4.

The signal processor 4 performs various image signal processing on the analog signal of a frame image transmitted from the electronic imaging device 3b. Specifically, the signal processor 4 receives the analog signal of the frame image transmitted from the electronic imaging device 3b and suitably adjusts the gain of the analog signal with respect to each of the RGB color components. Thereafter, the signal processor 4 converts the signal to digital data by means of an A/D converter (not shown) while sampling and holding the signal by means of a sample and hold circuit (not shown) and performs color processing including pixel interpolation and γ correction by means of a color processing circuit (not shown), so as to generate RGB data.

Further, the signal processor 4 outputs the RGB data thus generated to the memory 2, which serves as a buffer memory.

The image processor 5 includes an image acquiring section 5a, a smoothing section 5b, a first image generator 5c, an area specifying section 5d, a sharpening section 5e and a second image generator 5f.

For example, each of the components of the image processor 5 is constituted by a predetermined logic circuit. However, it is merely an example, and the configuration of the image processor 5 is not limited thereto.

The image acquiring section 5a acquires a target image on which eye enhancement (described below) is to be performed.

For example, when an image of a subject is taken by the imaging section 3, the image acquiring section 5a acquires the image data (RGB data) of the still image generated by the signal processor 4 from the memory 2.

The smoothing section (smoothing means) 5b performs smoothing on a flesh color area, which is considered to be a human face area.

That is, the smoothing section 5b acquires a copy of the image data of the still image acquired by the image acquiring section 5a, and smoothes the image by applying a predetermined smoothing filter (e.g. bilateral filter or the like) to calculate a weighted average of the pixel value of each pixel of the whole still image. As a result, the human face area included in the still image is also smoothed.

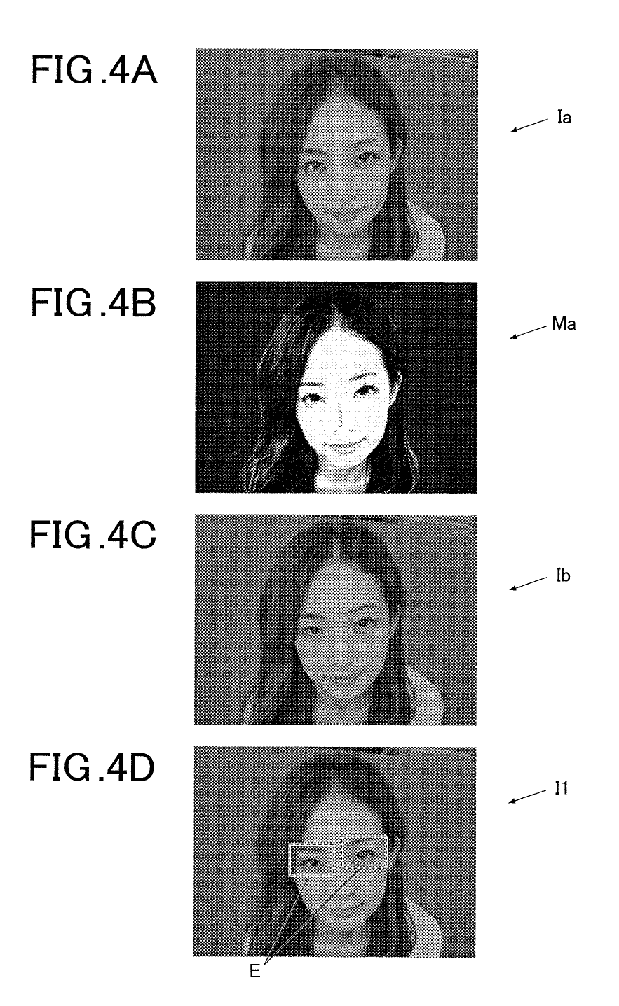

The first image generator 5c generates a first composite image I1 (see FIG. 4D) in which a human flesh color area is smoothed.

That is, the first image generator 5c acquires the image data (RG data) on which the smoothing section 5b has performed the smoothing, and develops the image data to convert it to luminance signals Y and color difference signals Cb, Cr, so as to generate a YUV data of a smoothed image Ia (see FIG. 4A). Then, the first image generator 5c performs flesh color detection on the image data of the generated smoothed image Ia for detecting a flesh color component, so as to generate a skin α map Ma (see FIG. 4B) that represents the detected flesh color component in 8-bit (0 to 255) gradation.

The skin α map Ma includes, for example, pixel values of 8-bit (0 to 255) gradation, each of which defines transparency. That is, the transparency (pixel values) represents the weight of each pixel of the smoothed image Ia corresponding to the skin α map Ma in alpha blending with a background image Ib (see FIG. 4C, described below).

The techniques of face detection and flesh color detection are known in the art, and the detailed description thereof is omitted here. Alternatively, the first image generator 5c may perform face detection on the smoothed image Ia and thereafter detect a flesh color component in the detected face area.

Further, the first image generator 5c acquires a copy of the image data (RGB data) of the still image acquired by the image acquiring section 5a, and develops the image data to convert it to luminance signals Y and color difference signals Cb, Cr so as to generate a YUV data of the background image Ib (see FIG. 4C) on which no smoothing is performed. Then, the first image generator 5c composites the smoothed image Ia with the background image Ib by using the skin α map Ma that defines the transparency, so as to generate the first composite image I1.

Specifically, for example, the first image generator 5c performs alpha bending with respect to each pixel of the smoothed image Ia in such a manner that the smoothed image Ia is transparent against the background image Ib when the transparency of the corresponding pixel in the skin α map Ma is “0”, a pixel of the background image Ib is overwritten by using the pixel value of the corresponding pixel of the smoothed image Ia when the transparency is “255”, and the pixel value of a pixel in the smoothed image Ia is blended with the pixel value of the corresponding pixel of the background image Ib according to the transparency value when the transparency is from “1” to “254”.

The technique of the above-described alpha blending is known in the art, and the detailed description thereof is omitted here. In FIG. 4D, which illustrates the first composite image I1, the eye areas E that are specified by the area specifying section 5d described below are schematically indicated by the dashed lines.

The transparency in the skin α map Ma may be binary values that represent whether the smoothed image Ia is transparent against the background image Ib.

In the development of the smoothed image Ia and the background image Ib by the first image generator 5c, for example, sharpening may be performed to enhance edges. Such sharpening is performed at a processing intensity lower than that of the sharpening by the sharpening section 5e described below.

The area specifying section (specifying means) 5d specifies eye areas E, each of which is an area including an eye in the human face area. Here, the term “eye” includes at least the term “iris and/or pupil”.

That is, the area specifying section 5d acquires a copy of the image data of the first composite image I1 generated by the first image generator 5c, and performs eye detection to specify the center coordinates of the irises (colored (non-white) parts of the eyeballs) of the right and left eyes respectively. Then, the area specifying section 5d specifies the eye areas (specific areas) E that extend a predetermined number of pixels in width and height from the specified center coordinates of the respective irises (see FIG. 4D). The eye areas E correspond to specific areas on which the sharpening section 5e (described below) performs the sharpening for reducing the smoothing effect. That is, the area specifying section 5d specifies the eye areas E in the smoothed human face area of the first composite image I1 generated by the first image generator 5c, which correspond to the specific areas on which sharpening is to be performed.

The technique of the eye detection is known in the art, and the detailed description thereof is omitted here. Alternatively, the area specifying section 5d may perform face detection on the first composite image I1 and thereafter detect eyes from the detected face area.

The sharpening section 5e performs sharpening on the eye areas E.

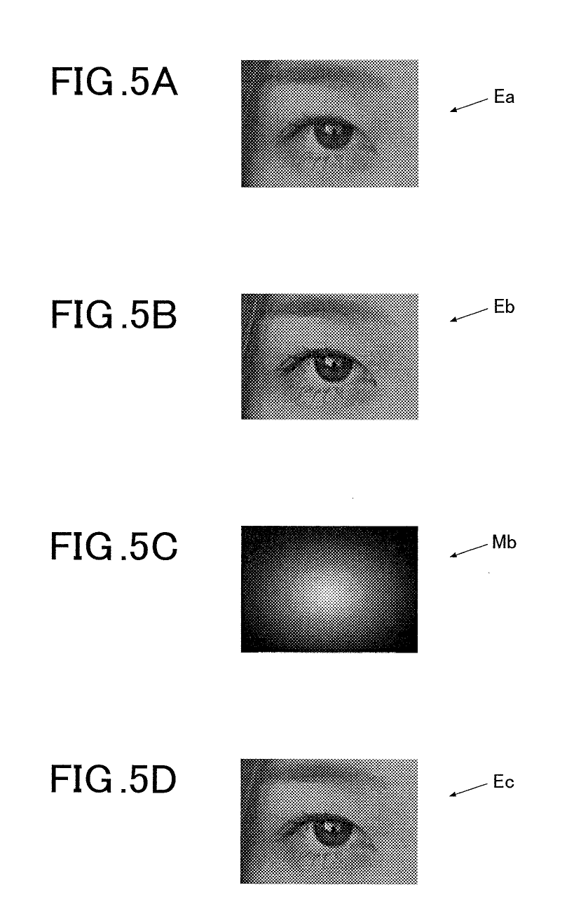

That is, the sharpening section 5e performs sharpening on each of the eye areas E specified by the area specifying section 5d so as to enhance edges in the areas. Specifically, the sharpening section 5e extracts the eye areas E specified by the area specifying section 5d from the first composite image I1 so as to generate respective eye area images Ea (see FIG. 5A). Then, the sharpening section 5e generates a copy of each of the generated eye area images Ea and performs the sharpening by using a filter with a predetermined size to enhance the parts (edges) where the brightness or the color changes drastically such as eye contours, boundaries between an iris and a sclera (a white part of the eyeball) and eyelashes, so as to generate respective enhanced eye area images Eb where the edges of the eye areas E are enhanced (see FIG. 5B). For example, the filter used in the embodiment has a target area size of 17×17 pixels in width and height, which is exclusively used for the eye areas E and is larger than the target area size of the filter used in the development (e.g. 5×5 pixels in width and height). Alternatively, the filter may have the same size as the filter used in the development but with a different filter coefficient (weight).

The effect of the smoothing, which has been performed on the first composite image I1 including the eye areas E, is reduced in the enhanced eye area images Eb. That is, the sharpening section 5e performs the sharpening for enhancing edges on the eye areas E in the first composite image I1 and thus serves as a reduction processing means that performs the processing different from the smoothing for reducing the smoothing effect.

The sharpening section 5e may change the processing intensity of the sharpening between the right and left eye areas E, E specified by the area specifying section 5d according to the degree of in-focus of their optical images.

That is, for example, when the human face is a profile or is taken from an oblique angle so that the distances to the right and left eyes are different from each other, there may be a case in which one eye is in focus while the other eye is out of focus. In such cases, for example, the sharpening section 5e may utilize the contrast information of the right and left eye areas E, E so that the processing intensity is comparatively higher in the in-focus eye area than in the out-of-focus eye area. Further, the sharpening section 5e may utilize the distances to the eye areas E, which are based on the result of multi-area AF by the imaging section 3. For example, when neither the right nor the left eye is in focus, the sharpening section 5e may calculate the difference in distance between an in-focus part and the right and left eyes, and comparatively increase the processing intensity of the sharpening with a decrease in the difference in distance.

FIG. 5A and FIG. 5B, and FIG. 5C and FIG. 5D described below illustrate the processing performed on the human right eye in the first composite image I1 (the eye at the left side in FIG. 4D), and approximately the same processing is performed on the left eye too.

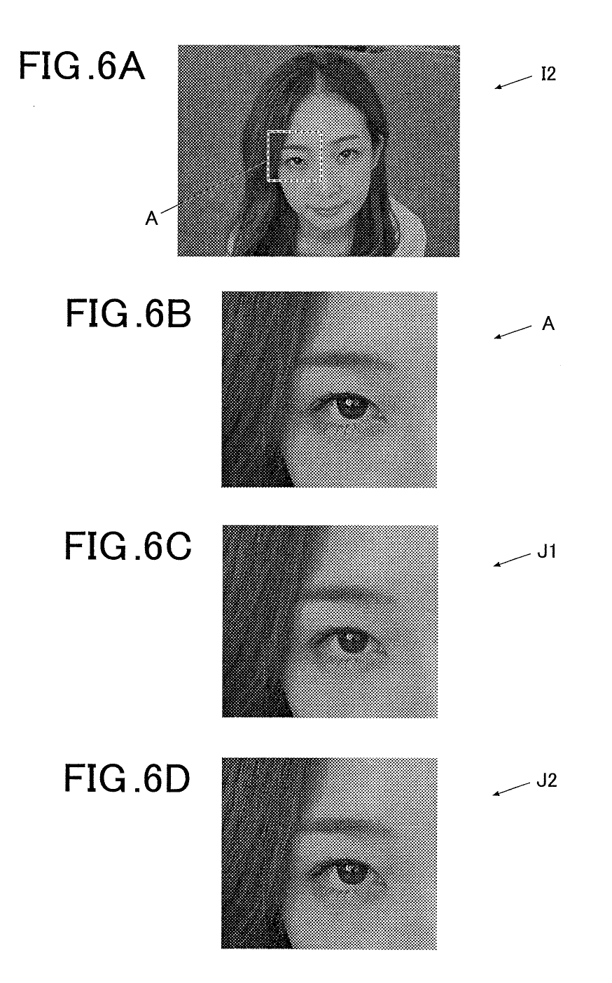

The second image generator 5f generates a second composite image I2 (see FIG. 6A) in which edges in the eye areas E are enhanced.

That is, for example, the second image generator 5f acquires an eye α map Mb (see FIG. 5C) stored in a predetermined storing means (e.g. the memory 2 and the like).

The eye α map Mb includes pixel values represented in 8-bit gradation (0 to 255), and the pixel values specify the transparency. That is, the transparency (pixel values) represents the weight of each pixel of the enhanced eye area images Eb corresponding to the eye α map Mb in alpha blending with eye area images Ea.

The second image generator 5f changes the size and shape of the acquired eye α map Mb to the size and shape of the enhanced eye area images Mb. Specifically, for example, the second image generator 5f changes the size of the eye α map Mb so that the area composed of pixels with a pixel value (transparency) of “255” has approximately the same size as the eyes in the enhanced eye area images Eb. Further, the second image generator 5f change the shape of the area in the eye α map Mb that is composed of pixels with any pixel value other than “0” according to the aspect ratio of the enhanced eye area images Eb so that the pixel values (transparency) of the eye α map Mb decrease from the centers of the eyes in the enhanced eye area images Eb toward the peripheries. For example, when the eyes are horizontally long, the second image generator 5f deforms the eye α map Mb into a horizontally long oval shape in which the area composed of pixels with a pixel value of “255” is located at the center and the pixel value of the other pixels is gradually decreased toward the end (see FIG. 5C).

For example, when the human face is rotated around the roll axis in the still image, the second image generator 5f may determine the slope of a line that connects the center coordinates of the irises (colored (non-white) parts of the eyeballs) of the right and left eyes detected in the first composite image I1 and adjust the angle (particularly the long axis direction of the oval) of the area of the eye α map Mb composed of pixels with any pixel value other than “0” to the slope of the determined line.

For example, the eye α map Mb, which is stored in the predetermined storing means (e.g. the memory 2 or the like), may have a size corresponding to the size of the eye areas E to be extracted. Alternatively, one of the quarters of the horizontally and vertically divided eye α map Mb may be stored, which is developed to four times the size of the original after it is acquired by the second image generator 5f. A common eye α map Mb may be used for both of the right and left eyes, or dedicated α maps such as a left eye α map and a right eye α map may be used for the respective eyes.

Further, the transparency of the eye α map Mb may be binary values that represent whether the enhanced eye area images Eb are transparent against the eye area images Ea.

Then, the second image generator 5f composites the enhanced eye area images Eb generated by the sharpening section Se with the respective eye area images Ea by using eye α map Mb that defines the transparency, so as to generate respective composite eye images Ec (see FIG. 5D).

Specifically, for example, the second image generator 5f performs alpha blending with respect to each pixel of the enhanced eye area images Eb in such a manner that the enhanced eye area images Eb are transparent against the eye area images Ea when the transparency of the corresponding pixel in the eye α map Mb is “0”, a pixel of the eye area images Ea is overwritten by using the pixel value of the corresponding pixel of the enhanced eye area images Eb when the transparency is “255”, and the pixel value of a pixel in the eye area images Ea is blended with the pixel value of the corresponding pixel of the enhanced eye area images Eb according to the transparency value when the transparency is from “1” to “254”. The second image generator 5f thus generates the composite eye images Ec with different processing intensities of the sharpening for reducing the smoothing effect, i.e. a composite eye image Ec in which the processing intensity of the sharpening is decreased from the centers of the irises in the composite eye images Ec toward the peripheries. The second image generator 5f together with the sharpening section 5e serves as the reduction processing means which performs the processing for reducing the smoothing effect on the specific areas specified by the area specifying section 5d in such a manner that the processing intensity decreases from the centers of the specific areas toward the peripheries.

Thereafter, the second image generator 5f composites (overlays) the generated composite eye images Ec to the corresponding areas in the first composite image I1, i.e. the areas in the first composite images I1 that are extracted as the eye area images Ea, so as to generate a second composite image I2 (see FIG. 6A).

The display 6 displays an image on a display screen of a display panel 6a.

That is, in a photographing mode such as a still image mode or a video mode for example, the display 6 displays a live-view image on the display screen of the display panel 6a in which the frame images generated by the imaging section 3 taking images of a subject are successively refreshed at a predetermined playback frame rate.

For example, the display panel 6a is constituted by a liquid-crystal display panel or an organic EL (electro-luminescence) display panel or the like. However, they are merely examples, and the display panel 6a is not limited thereto.

The image recorder 7, which is constituted by a non-volatile memory (flash memory) or the like, for example, records image data of still images and videos as recordings, which are coded in a predetermined compression format (e.g. JPEG format, MPEG format or the like) by the image processor 5.

For example, the image recorder 7 may be configured such that a recording medium (not shown) is detachably attached thereto, and the image recorder 7 may control the reading of data from the attached recording medium and the writing of data to the attached recording medium.

The operation input section 8 is used for predetermined operations of the imaging apparatus 100. Specifically, the operation input section 8 includes a shutter button to order the taking of an image of a subject, a selection button to order the selection of a photography mode, a replay mode or a function, a zoom button to order the adjustment of the zoom, and the like (all not shown).

When these buttons are operated by a user, the operation input section 8 outputs an operation order according to the operated button to the central controller 1. The central controller 1 then controls the components to perform a predetermined action (e.g. taking an image of a subject) according to the operation order output and input from the operation input section 8.

Eye Enhancement

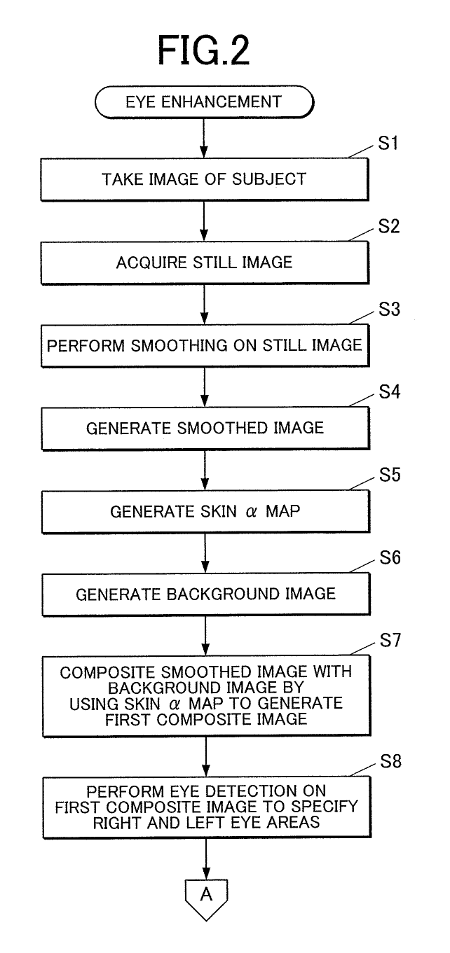

Next, the eye enhancement performed by the imaging apparatus 100 will be described referring to FIG. 2 to FIG. 6D.

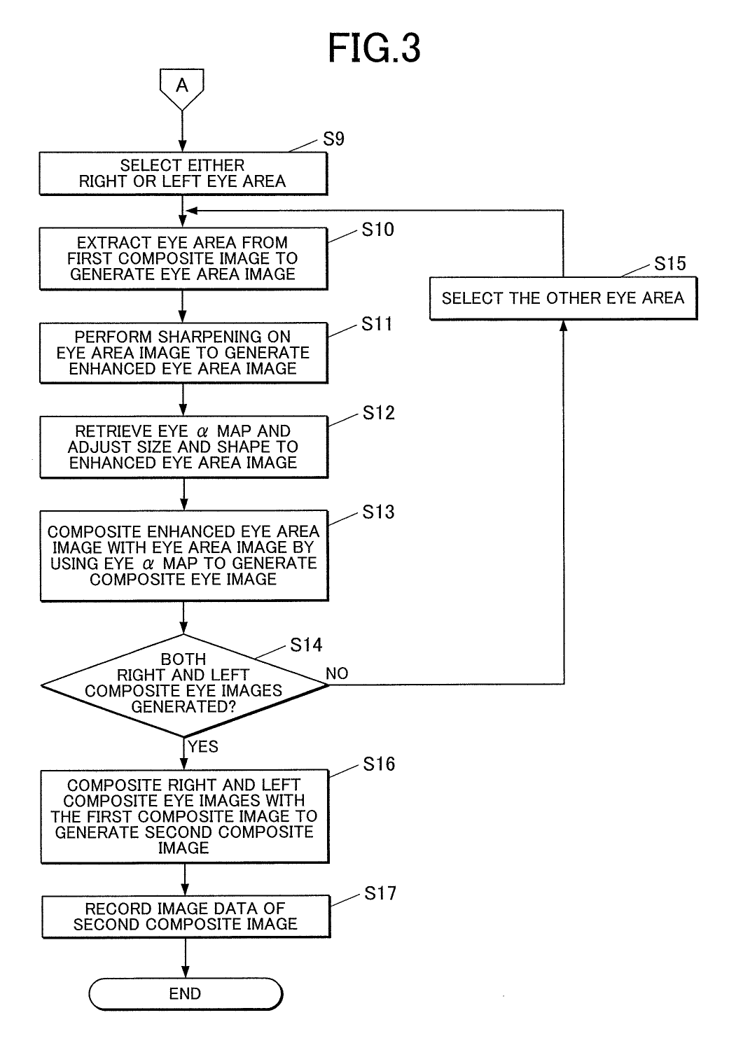

FIG. 2 and FIG. 3 is a flowchart of an example of the procedure of the eye enhancement. Further, FIG. 4A to FIG. 6D illustrate the eye enhancement.

As illustrated in FIG. 2, the imaging section 3 outputs a recording-use frame image of a subject to the signal processor 4 according to a user predetermined operation on the shutter button of the operation input section 8, and the signal processor 4 generates an image data (RGB data) of the still image of the subject and outputs it to the memory 2 (Step S1). Then, the image acquiring section 5a of the image processor 5 acquires the image data of the still image from the memory 2 as a target image for the eye enhancement (Step S2).

Then, the smoothing section 5b performs the smoothing on a copy of the image data of the still image acquired by the image acquiring section 5a so as to calculate a weighted average of the pixel value of each pixel of the whole still image (Step S3). Subsequently, the first image generator Sc acquires the image data (RGB data) on which the smoothing section 5b has performed the smoothing, and develops the image data to convert it to luminance signals Y and color difference signals Cb, Cr so as to generate a YUV data of the smoothed image Ia (see FIG. 4A) (Step S4).

Thereafter, the first image generator 5c performs the flesh color detection on the generated image data of the smoothed image Ia so as to generate the skin α map Ma in which the detected flesh color component is represented in 8-bit (0 to 255) gradation (see FIG. 4B) (Step S5).

Then, the first image generator 5c develops a copy of the image data of the still image acquired by the image acquiring section 5a to convert it to luminance signals Y and color difference signals Cb, Cr, so as to generate a YUV data of the background image Ib on which no smoothing is performed (see FIG. 4C) (Step S6).

Subsequently, the first image generator 5c composites the smoothed image Ia with the background image Ib by using the skin α map Ma (alpha blending), so as to generate the first composite image I1 (see FIG. 4D) (step S7).

Then, the area specifying section 5d performs the eye detection on the first composite image I1 so as to specify the right and left eye areas E, E (Step S8). Specifically, the area specifying section 5d performs the eye detection on a copy of the image data of the first composite image I1 generated by the first image generator 5c, so as to specify the center coordinates of the irises of the right and left eyes. Then, the area specifying section. 5d specifies the eye areas E that extend a predetermined number of pixels in width and height from the specified center coordinates of the respective irises (see FIG. 4D).

Then, as illustrated in FIG. 3, the sharpening section 5e selects either eye area E from the right and left eye areas E, E specified by the area specifying section 5d (e.g. the eye area E of the right eye) (Step S9).

Then, the sharpening section 5e extracts the selected eye area E from the first composite image I1 so as to generate the eye area image Ea (see FIG. 5A) (Step S10). Subsequently, the sharpening section 5e performs, for example, the sharpening on a copy of the generated eye area image Ea, which enhances the part (edge) where the brightness or the color changes drastically such as the eye contour, so as to generate the enhanced eye area image Eb (see FIG. 5B) (Step S 11).

Then, the second image generator 5f acquires the eye α map Mb (see FIG. 5C) from, for example, the predetermined storing means (e.g. the memory 2) and adjusts the size and shape of the acquired eye α map Mb to the size and shape of the enhanced eye area image Eb (Step S12).

Subsequently, the second image generator 5f composites the enhanced eye area image Eb generated by the sharpening section 5e with the eye area image Ea by using the eye α map Mb (alpha blending), so as to generate the composite eye image Ec (see FIG. 5D) (Step S13).

Thereafter, the second image generator 5f makes a determination as to whether both of the right and left composite eye images Ec are generated (Step S14).

When it is determined that the right and left composite eye images Ec are not completely generated (Step 14, No), the sharpening section 5e selects the other eye area E from the right and left eye areas E, E (e.g. the eye area E of the left eye) (Step S15), and the process returns to Step S10. Then, Step S10 to Step S13 are performed for the selected other eye area E in approximately the same manner as described above, so that the composite eye image Ec is generated.

When it is determined in Step S14 that both of the right and left composite eye images Ec are generated (Step S14, Yes), the second image generator 5f composites (overlays) the right and left composite eye images Ec to the areas in the first composite image I1 from which the respective eye area images Ea were extracted, so as to generate the second composite image I2 (see FIG. 6A) (Step S16).

Thereafter, the image processor 5 codes the image data of the second composite image I2 generated by the second image generator 5f in a predetermined compression format (e.g. JPEG format) and thereafter outputs it to the image recorder 7. The image recorder 7 records the image data of the input second composite image I2 (Step S17).

The effect of the eye enhancement will be described referring to FIG. 68 to FIG. 6E.

FIG. 6B is an enlargement of the rectangular area A surrounded by the dashed line in the second composite image I2 of FIG. 6A. FIG. 6C is an enlargement of a first comparison image J1 on which only the smoothing is performed, illustrating the part corresponding to the rectangular area A in the first comparison image J1. FIG. 6D is an enlargement of a second comparison image J2 on which the sharpening is further performed on the whole image before the smoothing, illustrating the part corresponding to the rectangular area A in the second comparison image J2.

As illustrated in FIG. 6C, the first comparison image J1 is rather blurry as a whole, in which the eyelashes and the eye contour are unfavorably blurred since no sharpening is performed. Further, as illustrated in FIG. 6D, the second comparison image J2 is unnatural, in which the hair has a rough texture since the edges included in the end of the face area such as the hair are also enhanced in addition to the edges included in the areas around the eyes.

In contrast, as illustrated in FIG. 6D, the second composite image I2 is a more natural image since the smoothing is performed and thereafter the sharpening is further performed on the eye areas E to enhance the edges, in which the edges included in the eyes such as the eyelashes and the eye contours are enhanced, while in the area around the eye areas E, the flesh color part in the face area is smoothed so that spots and wrinkles are less noticeable, and the edges included in the hair part are not enhanced.

In the above-described eye enhancement, both of the right and left eye areas E, E are selected as the processing targets. However, when either one of the eyes is covered with hair or the like or the human face is a profile in which only one eye is shown, only one eye area E including the other apparent eye may be selected as the processing target.

As described above, in the imaging apparatus 100 of the embodiment, the smoothing is performed on a human face area in a still image, and the sharpening for reducing the smoothing effect performed on eye areas (specific areas) E in the human face area. Therefore, eyelashes, eye contours and the like are not unfavorably blurred in the eye areas E in the human face area, and the negative effects of the smoothing on the image can be reduced.

In particular, the eye areas E on which the sharpening for reducing the smoothing effect is to be performed are specified in the human face area on which the smoothing is performed, and the sharpening is performed on the specified eye areas E. Therefore, the negative effects of the smoothing on the image can be reduced more effectively. That is, when the sharpening is firstly performed, wrinkles and the like are unnecessarily enhanced, and the subsequent smoothing for making the wrinkles less noticeable cannot produce a sufficient effect. Further, when the eye areas E are masked so that the smoothing is performed on the other area, the edges included in the eyes such as eyelashes and eye contours cannot be enhanced. When the sharpening is thereafter performed, the edges included in the end of the face area (e.g. hair and the like) may be unnecessarily enhanced.

Since another different processing, which is the sharpening for reducing the smoothing effect, is performed after the smoothing, controls that change the configuration of the sharpening can be made according to the result of the smoothing. Specifically, the processing intensity of the sharpening can be increased or decreased according to the result of the smoothing. In such cases, the degree of reducing the smoothing effect can be adjusted more finely compared to the case in which only the processing intensity of the smoothing is adjusted. Therefore, the negative effects of the smoothing on an image can be reduced more effectively.

The sharpening is performed on the eye areas (specific areas) E specified in the human face area such that the processing intensity decreases from the centers of the eye areas E toward the peripheries. Therefore, the edges in the eye areas E are naturally enhanced, and the image is less likely to provoke a strange feeling in a viewer. In particular, when the sharpening is performed on the specified plurality of eye areas at different processing intensities according to the degree of in-focus of their optical images, the edges included in the eye areas can be enhanced more naturally.

The present invention is not limited to the above-described embodiment, and a variety of improvements and changes can be made without departing from the spirit of the present invention.

For example, the above-described embodiment is an example in which the specific area is the eye area E that includes the eyes. However, it is merely an example, and the present invention is not limited thereto. An arbitrary area may be selected as the specific area, such as a nose area that includes the nose or a mouth area that includes the mouth. In such cases, the control may involve changing the configuration of the processing for reducing the smoothing effect according to the specified specific area. That is, in the case of a nose area for example, it is preferred that the sharpening on the nose line and the like is performed by using a filter with a size and a filter coefficient (weight) more suitable for enhancing a low-frequency component, since the nose line has unclear edges compared to an eye contour, the boundary between an iris and a sclera and an eyelash.

The above-described embodiment is an example in which the sharpening is performed as the processing for reducing the smoothing effect. However, it is merely an example, and the present invention is not limited thereto. The sharpening can be suitably changed to any other processing that is different from the smoothing and can reduce the smoothing effect.

The above-described embodiment is an example in which the first composite image I1 with the smoothed flesh color part in the face area is generated by compositing the smoothed image Ia with the background image Ib. However, it is merely an example, and the present invention is not limited thereto. For example, the first composite image I1 may be generated by performing the smoothing only on the face area in the non-smoothed background image Ib.

Further, the second composite image I2 is generated by compositing the composite eye images Ec, which is generated by compositing the enhanced eye area images Eb with the eye area images Ea, with the first composite image I1. However, it is merely an example, and the present invention is not limited thereto. For example, the second composite image I2 may be generated by compositing the enhanced eye area images Eb with the first composite image I1.

In the above-described embodiment, the processing (sharpening) for reducing the smoothing effect is performed on the eye areas E (specific areas) after the smoothing is performed on the face area. However, it is merely an example, and the present invention is not limited thereto. For example, the sharpening for reducing the smoothing effect may be performed on specific areas, and thereafter the smoothing may be performed on the human face area including specific areas on which the processing for reducing the smoothing effect has been performed. That is, the processing for reducing the smoothing effect may be performed either on non-smoothed specific areas or on smoothed specific areas.

The configuration of the imaging apparatus 100 of the above-described embodiment is merely an example, and the present invention is not limited thereto. Further, the imaging apparatus 100 is an example of the image processing apparatus, and the present invention is not limited thereto. An appropriate selection can be made as to whether or not the image processing apparatus has an imaging function.

That is, when the image processing apparatus does not have an imaging function, the image acquiring section 5a may acquire an image data of a still image recorded in the image recorder 7 from the image recorder 7 as a target image for eye enhancement. In this case, the sharpening may be performed at different processing intensities on the right and left eye areas E, E according to the degree of in--focus of their optical images. For example, the distances to the eye areas E, E, which is included as the Exif (exchangeable image file format) information, may be utilized for this purpose.

In addition, in the above-described embodiment, the functions of the smoothing means, the specifying means and the reduction processing means are achieved by a control of the central controller 1 for operation of the smoothing section 5b, the area specifying section 5d and the sharpening section 5e. However, the present invention is not limited thereto, and the functions may be achieved by an execution of a predetermined program or the like by the CPU of the central controller 1.

In this case, a program including a smoothing routine, a specifying routine and a reducing routine is stored in a program memory (not shown). With the smoothing routine, the CPU of the central controller 1 may achieve the function of smoothing the human face area in the image. With the specifying routine, the CPU of the central controller 1 may achieve the function of specifying a specific area in the human face area. With the reducing routine, the CPU of the central controller 1 may achieve the function of performing the processing for reducing the smoothing effect on the specified specific area.

In addition to a ROM or a hard disk, a portable recording medium, such as a flash memory or another non-volatile memory, or a CD-ROM can be applied as a computer-readable medium that stores the program for executing the above-described processing. Further, a carrier wave is also applicable as a medium for providing the data of the program according to the present invention through a predetermined communication network.

While some embodiments of the present invention are described, the scope of the present invention is not limited to these embodiments but encompasses the scope of the invention recited in the claims and the equivalents thereof.

What is claimed is:

1. An image processing apparatus, comprising:
a processor that is configured to:
perform smoothing on a human face area in an image;
specify at least one specific area in the human face area; and
perform processing for reducing an effect of smoothing on the specified specific area.

2. The image processing apparatus according to claim 1,
wherein the processor is configured to:
specify the specific area in the human face area on which the smoothing has been performed, the specific area being a target of the processing for reducing the effect of the smoothing; and
perform the processing for reducing the effect of the smoothing on the specified specific area.

3. The image processing apparatus according to claim 1,
wherein the processor is configured to:
perform the processing for reducing the effect of the smoothing on the specified specific area before the smoothing; and
perform the smoothing on the human face area with the specific area on which the processing for reducing the effect of the smoothing has been performed.

4. The image processing apparatus according to claims 1,
wherein the processor is configured to:
specify an area including an eye as the specific area.

5. The image processing apparatus according to claims 1,
wherein the processor is configured to:
perform sharpening that enhances an edge as the processing for reducing the effect of the smoothing.

6. The image processing apparatus according to claim 1,
wherein the processor is configured to:
change a configuration of the processing for reducing the effect of the smoothing according to a result of the smoothing.

7. The image processing apparatus according to claim 6,
wherein the processor is configured to:
perform the processing for reducing the effect of the smoothing on the specified specific area according to a result of the smoothing such that a processing intensity decreases from a center of the specific area toward an end.

8. The image processing apparatus according to claim 6,
wherein the processor is configured to:
change a configuration of the processing for reducing the effect of the smoothing on each of the specified specific area when the at least one specific area comprises a plurality of specific areas.

9. The image processing apparatus according to claim 8,
wherein the processor is configured to:
perform the processing for reducing the effect of the smoothing at different processing intensities with respect to each of the specified plurality of specific areas according to a degree of in-focus of optical images of the specified plurality of specific areas.

10. An image processing method by using an image processing apparatus, comprising:
performing smoothing on a human face area in an image;
specifying at least one specific area in the human face area; and
performing processing for reducing an effect of smoothing on the specified specific area.

11. A non-transitory computer-readable storage medium storing therein a program that makes a computer of an image processing apparatus achieve the functions of:
performing smoothing on a human face area in an image;
specifying at least one specific area in the human face area; and
performing processing for reducing an effect of smoothing on the specified specific area.
